(19) United States
(12) Patent Application Publication
(10) Pub. No.: US 2022/0292232 A1
(43) Pub. Date: Sep. 15, 2022

(54) Method and Apparatus for the State Estimation of an Electrical Grid

(71) Applicant: Siemens Aktiengesellschaft, Munchen (DE)

(72) Inventors: Mathias Duckheim, Erlangen (DE); Thomas Werner, Rednitzhembach (DE)

(73) Assignee: Siemens Aktiengesellschaft, München (DE)

(21) Appl. No.: 17/690,592

(22) Filed: Mar. 9, 2022

(30) Foreign Application Priority Data
Mar. 10, 2021 (EP) 21161840.0

(51) Int. Cl. G06F 30/18; H02J 13/00; G01R 19/25; G06F 30/27

(52) U.S. Cl. CPC G06F 30/18; H02J 13/00002; G01R 19/2513; G06F 30/27; G06F 2111/08

(57) ABSTRACT

Various embodiments of the teachings herein include a method for ascertaining a state of an electrical grid. The state of the electrical grid is represented by ascertained voltages and ascertained phase angles at one or more grid nodes of the electrical grid. The method may include calculating the state using a computing unit, wherein the computing unit employs an iterative, numerical method on the basis of a plurality of measured values associated with the electrical grid. The numeral method begins with an initial value. The initial value includes an initial state ascertained from the measured values by an artificial neural network.

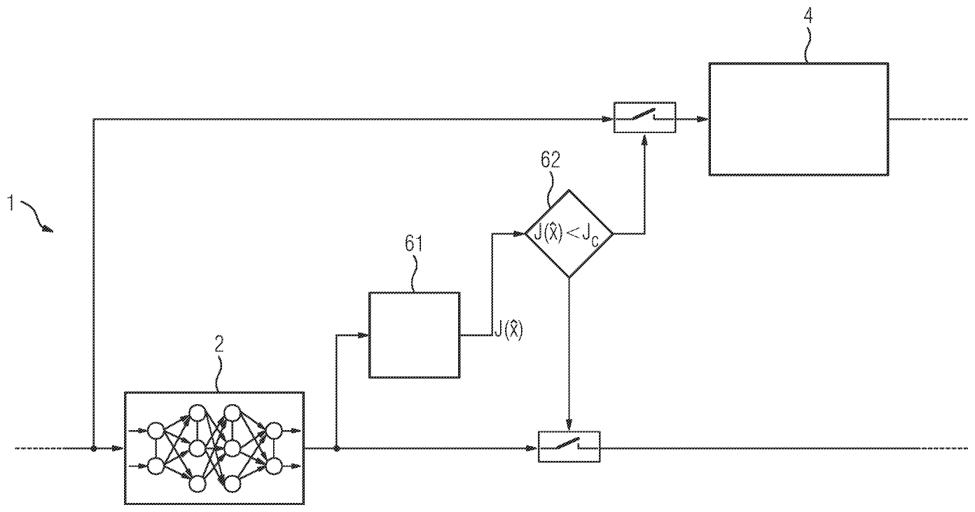

### CROSS-REFERENCE TO RELATED APPLICATIONS

This application claims priority to EP Application No. 21161840.0 filed Mar. 10, 2021, the contents of which are hereby incorporated by reference in their entirety.

### TECHNICAL FIELD

The present disclosure relates to power grids. Various embodiments may include methods and/or apparatuses for estimating the state of an electrical grid.

### BACKGROUND

A state estimation of an electrical grid (power grid) involves the most complete and consistent ascertainment of the state of the power grid possible from a plurality of measurements. The state of a power grid is characterized here by the voltages and phase angles at the grid nodes of the power grid.

Measurements fundamentally have measurement errors that result, in particular, from communication delays and/or configuration errors. The state ascertained in the context of a state estimation thus corresponds to an estimated value of the true, real state of the electrical grid. In other words, the state that best matches the measurements or the measured values in terms of an optimization problem is ascertained by means of a state estimation. Even though only an estimation of the true state can be achieved, the ascertained, i.e. the estimated, state thus forms the basis for multiple higher-order grid applications such as for safety reports, voltage controls and/or preventive and corrective SCOPF (Security Constraint Optimal Power Flow).

The state of a power grid is time-dependent, so that a state estimation typically takes place at regular time intervals. For example, known monitoring, control and data acquisition systems (Supervisory Control and Data Acquisition, abbreviated to SCADA) have a time interval of about one minute for a state estimation. In other words, the technical challenge is that the state estimation must take place in real time so that the higher-order grid applications can be employed and concluded. A further technical challenge is that the state estimation performed in real time must also exhibit sufficient accuracy.

### SUMMARY

The teachings of the present disclosure may be used to ascertain an improved state estimation for an electrical grid. For example, some embodiments of the teachings herein may include a method for ascertaining a state x (42) of an electrical grid, wherein the state x (42) of the electrical grid is represented by ascertained voltages and ascertained phase angles at one or more grid nodes of the electrical grid, wherein the ascertainment of the state x (42) is performed by a computing unit, by means of which, on the basis of a plurality of measured values z (1) associated with the electrical grid, the state x (42) of the electrical grid is calculated by an iterative, numerical method (4) beginning from an initial value x₀, characterized in that an initial state ascertained from the measured values z (1) by means of an artificial neural network (2) is used as the initial value x₀.

In some embodiments, Newton's method is used as the iterative numerical method (4).

In some embodiments, the measured values (1) constitute a measurement vector z comprising voltages, currents, real powers and/or reactive powers associated with and acquired by the grid nodes and/or cables of the electrical grid.

In some embodiments, the state (42) is formed by a state vector x that comprises the voltages and phase angles at the respective grid nodes of the electrical grid.

In some embodiments, the measured values z (1) are provided by a control system of the electrical grid.

In some embodiments, a target function J(x) is minimized by the iterative numerical method (4), wherein the target function J(x) comprises a weighted, quadratic deviation between the measured values z (1) and a measurement model function h(x) that depends on the state x (42) to be ascertained.

In some embodiments, the initial state \hat{x} ascertained by means of the artificial neural network (2) is used as the initial value x₀ if its target function value J(\hat{x}) is greater than or equal to a threshold value J_{c}.

In some embodiments, the state \hat{x} ascertained by means of the artificial neural network (2) is not used as the initial value x₀ if the state \hat{x} fails a chi-squared test with a specified probability threshold.

In some embodiments, a value between 95 percent and 100 percent, in particular between 99 percent and 100 percent, is used as the probability threshold.

In some embodiments, the artificial neural network (2) is trained and designed in such a way as to ascertain states of the electrical grid from measured values associated with the electrical grid.

In some embodiments, the artificial neural network (2) was trained by means of a training data set, wherein the training data set comprises measured values associated with the electrical grid and states of the electrical grid belonging to the measured values.

In some embodiments, the training data set is formed by one or a plurality of simulations and/or historic measured values and associated historic states of the electrical grid.

In some embodiments, it is carried out repeatedly in accordance with specified time intervals.

As another example, some embodiments include a method for the control of an electrical grid, wherein the control takes place on the basis of an ascertained state x (42) of the electrical grid which is formed by ascertained voltages and ascertained phase angles at one or a plurality of grid nodes of the electrical grid, characterized in that the state x (42) is ascertained by means of a method as claimed in one of claims 1 to 13.

As another example, some embodiments include an apparatus for ascertaining a state x (42) of an electrical grid, comprising a computing unit, wherein the state x (42) of the electrical grid is formed by voltages and phase angles at one or a plurality of grid nodes of the electrical grid, and the computing unit is designed so as to calculate the state x (42) of the electrical grid on the basis of a plurality of measured values z (1) associated with the electrical grid by an iterative numerical method (4) starting from an initial value x₀, characterized in that the computing unit is designed so as to use an initial state \hat{x} ascertained by means of an artificial neural network (2) from the measured values z (1) as the initial value x₀.

### BRIEF DESCRIPTION OF THE DRAWINGS

Further advantages, features, and details of the teachings herein emerge from the exemplary embodiments described below and with reference to the drawing.

The single FIGURE here shows, in schematic form, a flow diagram of a state estimation according to an embodiment incorporating teachings of the present disclosure.

### DETAILED DESCRIPTION

The present disclosure described methods and/or systems for ascertaining a state x of an electrical grid. In some embodiments, the state x of the electrical grid is represented by ascertained voltages and ascertained phase angles at one or more grid nodes of the electrical grid, and the ascertainment of the state x is performed by a computing unit, by means of which, on the basis of a plurality of measured values z associated with the electrical grid, the state x of the electrical grid is calculated by an iterative, numerical method beginning from an initial value x₀, is characterized in that an initial state \hat{x} ascertained from the measured values z by means of an artificial neural network (AI; ANN) is used as the initial value x₀.

The methods described herein and/or one or a plurality of functions, features and/or steps of the method according to the invention and/or one of its embodiments can be computer-aided. In particular, the iterative numerical method may be carried out in a computer-aided manner by the computing unit. A numerical, iterative method (iteration) is a method in which an approximation to a solution is achieved through multiple repetition of steps that are the same or essentially the same. An initial value from which the iterative method begins is necessary for this. Newton's method is, for example, an iterative method.

The state of an electrical grid or of a power grid with n grid nodes is represented by voltages U_{i=1, . . . n} and phase angles δ_{i=1, . . . n} at the grid nodes. The voltages and phase angles are referred to as state variables. A state estimation allows a consistent data set for describing the state of a power grid to be provided. A consistent data set is typically non-redundant and self-consistent and represents the state of the electrical grid. Further dependent variables associated with the electrical grid can be ascertained from the ascertained state, in particular in combination with further grid data. The node voltages, with their magnitude and phase angle, constitute such a state. In other words, the state of an electrical grid or of a power grid with n grid nodes is represented by node voltages or voltages U_{i=1, . . . n} and phase angles δ_{i=1, . . . n} at the grid nodes. As a result, in particular, of measurement errors and insufficient acquisition of state variables, only an estimation of the true state of the electrical grid can be achieved.

In some embodiments, the state of the electrical grid is ascertained from measured values. The measured variables that belong to the measured values are, in particular, specified in such a way that they are easily accessible and acquirable. This is the case, for example, for real and reactive power flows, powers withdrawn and fed in, and voltages. The measured variables are typically dependent on one another and redundant, meaning that more measured values are used than state variables. At least twice as many measured values as state variables are preferably provided and used.

In some embodiments, the ascertainment of the state that corresponds to an estimated value for the true state of the electrical grid is done by means of a numerical, iterative method. This can be referred to as a classic state estimation. An initial value at which the iterative method begins is necessary for such an iterative method. In other words, an initial state is required.

In some embodiments, the initial state ascertained from the measured values by means of the artificial neural network is used as the initial value (seed). The artificial neural network is designed and trained here in such a way that it can process the measured values as input and can convert them into a state in accordance with the state variables. Such an artificial neural network can be provided by means of known data (input: measured values; output: state) and known training methods.

In some embodiments, the initial value for the classic, iterative method is thus provided by an appropriately trained artificial neural network. A first, fast estimation for the state of the electrical grid (initial state) is provided by the artificial neural network. The initial state ascertained in this way is used as the initial value, so that a significantly faster convergence of the iterative method is thereby achieved. This is therefore the case because it can be expected that the initial state ascertained by means of the artificial network lies significantly closer to the convergence point of the classic estimator (iterative method). In particular, the number of iterations, i.e. the number of iteration steps required to reach the specified accuracy, is reduced. As a result, the reduction in time required for the classic estimation method (iterative method) is made possible without sacrificing the accuracy.

The accuracy of the initial state that was ascertained by means of the neural network is, furthermore, unknown, and it also depends on the quality and the scope of the training of the artificial neural network. The initial state can therefore not be employed immediately as a state estimation. The present invention overcomes this disadvantage of the artificial neural network, in that the ascertained initial state is only employed as an initial value for a classic state estimation.

The teachings of the present disclosure may therefore enable a faster and/or more accurate state estimation. For examples, some embodiments of the teachings herein include a method for the control of an electrical grid, wherein the control takes place on the basis of an ascertained state x of the electrical grid which is formed by ascertained voltages and ascertained phase angles at one or a plurality of grid nodes of the electrical grid, is characterized in that the state x is ascertained by means of a method as claimed in one of claims 1 to 13. Similar and equivalent advantages and embodiments of the methods for the control of the electrical grid emerge for the method for ascertaining the state.

In some embodiments, an apparatus for ascertaining a state x of an electrical grid (state estimator), comprises a computing unit, wherein the state x of the electrical grid is formed by voltages and phase angles at one or a plurality of grid nodes of the electrical grid, and the computing unit is designed so as to calculate the state x of the electrical grid on the basis of a plurality of measured values z associated with the electrical grid by an iterative numerical method starting from an initial value x₀, is characterized in that the computing unit is designed so as to use an initial state \hat{x} ascertained by means of an artificial neural network from the measured values z as the initial value x₀.

Similar and equivalent advantages and embodiments of the apparatus according to the invention emerge for the method according to the invention for ascertaining the state.

In some embodiments, Newton's method is employed as the iterative numerical method. A fast quadratic convergence is achieved, in particular when an initial value is already good which, in the present case, is provided by the artificial neural network. In other words, the initial value ascertained by means of the artificial neural network ensures the convergence and, what is more, the fast convergence of the Newton's method, so that the Newton's method and the ascertainment of the initial value interact synergetically due to the artificial neural network.

In some embodiments, the measured values constitute a measurement vector z comprising voltages, currents, real powers and/or reactive powers associated with and acquired by the grid nodes and/or cables of the electrical grid. The measured variables mentioned for a power grid are easily accessible and are thus particularly well suited to the ascertainment of the state. Furthermore, forming a measurement vector of the form z=(Pᵢⱼ, Qᵢⱼ, Pᵢ, Qᵢ, Uᵢ, Uᵢ)^{T} is numerically advantageous, wherein Pᵢⱼ represents the acquired flows of real power from the grid node i to the grid node j, Qᵢⱼ represents the acquired flows of reactive power from the grid node i to the grid node j, Pᵢ represents the real power at the grid node i, Qᵢ represents the reactive power at the grid node i, Uᵢ represents the voltage at the grid node i, and Iᵢ represents the currents at the grid node i. The variables mentioned are signed and can also be formed as a vector. Mathematically equivalent expressions of the measurement vector, created, for example, by multiplication with a scalar, by transposing and/or by permutation of its elements, can accordingly be provided. It is also possible for measured variables to be omitted or for further measured variables to be added.

In some embodiments, the state is formed by a state vector x that comprises the voltages and phase angles at the respective grid nodes of the electrical grid. The state vector is, for example, formed by x=(Uᵢ, δᵢ)^{T}=(U₁, . . . , Uₙ, δ₁, . . . δₙ)^{T}.

In some embodiments, the measured values z are provided by a control system of the electrical grid. The state estimation can thus be based on advantageous and current measured values. Such a control system is, in particular, formed by a monitoring, control and data acquisition system, i.e. by a SCADA (Supervisory Control and Data Acquisition) system.

In some embodiments, a target function J(x) is minimized by the iterative numerical method, wherein the target function J(x) comprises a weighted, quadratic deviation between the measured values z and a measurement model function h(x) that depends on the state x to be ascertained. In other words, for the measurement model function, a weighted mean squared error (weighted MSE) method is used for the classic state estimation that takes place by means of the iterative method on the basis of the initial value according to the invention. The measurement model z=h(x)+e or zᵢ=hᵢ(x₁, . . . , xₙ)+eᵢ for i=1, . . . , m with m>n measurement values is used, wherein e or eᵢ represent errors in the measurement model. The state is ascertained on the basis of this measurement model by minimizing the error, i.e. by minimizing the target function J(x)=Σᵢ₌₁^{m} wᵢ(zᵢ−hᵢ(x))². Here, wᵢ are the weights, which are preferably specified as wᵢ=Rᵢᵢ, where R represents the covariance matrix of the measurement values. As a result of the minimization mentioned, the state x may be determined in such a way that its error in respect of the measured values that are present or acquired, and in respect of the measurement model function, is as small as possible. The measurement model function is typically non-linear. A linear measurement model function, for example in the form of a matrix, can nevertheless be provided. The measurement model function is the model that underlies the classic state estimation. It indicates how the acquired measured values or measured variables are derived from the state, for example how the real power in a cable depends on the voltages and phase angles of the associated grid nodes. Fundamentally, a measurement model function is provided.

In some embodiments, the initial state \hat{x} ascertained by means of the artificial neural network is used as the initial value x₀ if its target function value J(\hat{x}) is greater than or equal to a threshold value J_{c}. In other words, the ascertained initial state is only used as the initial value for the classic state estimation if it is not accurate enough in respect of the target function, i.e. when its target function value J(\hat{x}) is greater than or equal to the threshold value J_{c}. As a result, a test for the accuracy or for the deviation of the initial state ascertained by means of the artificial neural network may be carried out. If the initial state ascertained by the AI is already sufficiently accurate, i.e. if J(\hat{x})<J_{c}, it could already be used as the state estimation. If, on the other hand, the initial state in respect of the J-measure is not sufficiently accurate, i.e. J(\hat{x})≥J_{c}, then a classic state estimation is carried out with x₀=\hat{x}. In other words, a subsequent validation (post validation) of the initial state ascertained by the AI takes place in accordance with a test of its J residual or J remainder (largest residual test). Overall, the computing time for ascertaining the state can be reduced in this way.

In some embodiments, the state ascertained by the AI is not used as the initial value, since this is not as good as a fixed standard initial value, meaning that J(\hat{x})≥J_{c}. A classic state estimation on the basis of the standard initial value is then carried out in this case.

In some embodiments, the state \hat{x} ascertained by means of the artificial neural network is not used as the initial value x₀ if the ascertained state \hat{x} fails a chi-squared test with a specified probability threshold. In this case, the classic state estimator is applied, and its result is output as the final estimation result, i.e. as the final state. A specified standard initial value is used here as the initial value. The initial value ascertained by the AI is, in other words, discarded.

In other words, a chi-squared test of the state ascertained by the AI (estimated state) may be carried out. Only if the state ascertained by the AI fails the chi-squared test can it be employed as the initial value for the classic state estimation, or the classic state estimation can be carried out in accordance with its standard initial value. Here, in the event that the chi-squared test fails, a classic state estimation can be carried out with an initial value that is better than the one ascertained by the AI, for example a specified standard initial value. Further computing time can be saved in this way.

If the initial state already passes the chi-squared test, it can be employed immediately as the state estimation, which means that in this case the state is already ascertained by the initial state. The chi-squared test here ascertains whether the initial value is probable with respect to the specified probability threshold, i.e. whether this is more probable than the specified probability threshold. By specifying the probability threshold, a compromise can thus be reached between computing time and required accuracy. In other words, using the chi-squared test, it is ascertained whether a state is probable, i.e. whether it is more probable than the specified probability threshold. Other similar tests are provided, for example a normalized maximum residual test.

In some embodiments, the classic (slow) state estimation is only to be carried out and used if a probability that is too low has been ascertained in the chi-squared test for an estimation result of the AI-based state estimator, i.e. for the state ascertained by the artificial neural network. This method benefits from the speed of the AI-based state estimator, and overcomes the disadvantage of variable quality of the artificial neural network through the conditional use of the classic state estimator.

In some embodiments, a value between 95 percent and 100 percent, in particular between 99 percent and 100 percent, is used as the probability threshold. This ensures that a further classic state estimation is not necessary for states that are already probable by way of the ascertained AI. Computing time for ascertaining the state can in this way be advantageously reduced.

In some embodiments, the artificial neural network (AI) is trained and designed in such a way as to ascertain states of the electrical grid from measured values associated with the electrical grid.

The training of the AI may take place here by means of a training data set, wherein the training data set comprises measurement values associated with the electrical grid and states of the electrical grid belonging to the measurement values. This ensures that the AI can, on the basis of the measured values, fundamentally ascertain a state in the sense of a classic state estimation, which can then be employed as the initial value of the classic state estimation.

In some embodiments, the training data set is formed by one or a plurality of simulations and/or historic measured values and associated historic states of the electrical grid. The AI is in this way adequately well trained, so that the ascertained initial state already comes close to the state to be ascertained. A fast convergence of the classic state estimation is enabled by this, so that the computing time can be reduced and/or an improved accuracy achieved.

In some embodiments, the method and/or one of its embodiments is carried out repeatedly in accordance with specified time intervals. An ascertainment of the state of the electrical grid in real time is thereby enabled. In other words, a real-time state estimation occurs. In some embodiments, this is particularly enabled by the use of the initial state ascertained by the AI, since the overall computing time of the state estimation can thereby be significantly reduced.

The FIGURE shows a state estimation according to an embodiment of the present teachings, in which a state 42 of an electrical grid is ascertained. In the context of a state estimation, as is shown in the FIGURE, voltages and phase angles of an electrical grid (power grid) are ascertained as accurately as possible at its grid nodes, i.e. are estimated. The ascertainment of the state of the power grid in this sense is to be understood according to the present embodiment. It is thus not the true state of the power grid that is ascertained, which is practically impossible, but a state 42 is ascertained which, in respect of acquired measurement values, comes as close as possible to the true state of the power grid, i.e. that exhibits the smallest error in respect of the measured values.

The state estimation (ascertaining a state 42 of the electrical grid) is based on measured values 1 of measured variables. The measured values of a power grid are typically acquired by a SCADA system and/or are collected centrally by this and provided for the state estimation or a state estimator (apparatus for ascertaining a state 42 of the power grid). The measured variables are preferably cable-focused flows of real power and/or reactive power flows and/or grid node-focused real powers, reactive powers, voltages and/or current magnitudes (currents). The measured values 1 are grouped into a measurement vector.

The measured values 1 provided are supplied as input to an artificial neural network 2 (AI or ANN). The AI 2 is appropriately trained and designed to ascertain a state of the power grid from the supplied measurement values 1, i.e. to carry out an AI-based state estimation. A first state estimation is thus carried out by means of the AI 2, which takes less time when compared with a classic state estimation.

A disadvantage of the AI-based state estimation 2 is that it is not ensured whether the state ascertained by the AI 2 is probable or realistic. In particular, the AI 2 typically supplies an insufficiently accurate result for states that are unusual in terms of its training data set.

In the present case, the disadvantage mentioned of the AI 2 is overcome by a second state estimation 4. The second state estimation 4 takes place on the basis of a model measurement function h(x) of the power grid by means of an iterative numerical method. The second state estimation 4 thus forms a classic state estimation.

An initial value for the iterative method, i.e. an initial state, is necessary for the classic state estimation 4. The state ascertained by the AI 2 is used in the present case as the initial state or as the initial value. As a result, the iteration already begins at an improved initial value, so that a better convergence, and thus a temporally faster, classic state estimation 4 is enabled. This is particularly advantageous when Newton's method is used, as indicated in the state estimation box 4.

In some embodiments, a test of the state ascertained by the AI 2 occurs, which is downstream of the AI 2 or upstream of the classic state estimation 4. An ascertainment is made here of whether the state ascertained by the AI 2 is already sufficiently accurate, and thus a second classic state estimation 4 may not be necessary.

In other words, a classic state estimation 4 on the basis of the initial value ascertained by the AI 2 is only carried out if this does not pass the test mentioned (post validation). Various test methods can be used here, for example a chi-squared test or what is known as a h(x) test based on the model measurement function h(x). In the context of the h(x) test, the potentially weighted total square deviation of the measured values of the measurement model function that depends on the state to be tested is ascertained (identified by the reference sign 61).

In other words, J(x)=Σᵢ₌₁^{m} wᵢ(zᵢ−hᵢ(x))² is determined, wherein x is the same as the state x ascertained by the AI 2. If J(\hat{x}) is smaller than a specified threshold value J_{c}, i.e. if J(\hat{x})<J_{c}, a second, classic state estimation 4 is not necessary. In other words, the classic state estimation 4 is carried out if J(\hat{x})≥J_{c}. If J(\hat{x})<J_{c}, the state x 42 to be ascertained is already specified by the state \hat{x} ascertained by the AI 2, meaning that x=\hat{x} is set. The condition J(\hat{x})<J_{c} or J(\hat{x})≥J_{c} is identified in the FIGURE by the reference sign 62.

If a classic state estimation 4 is carried out, i.e. if J(\hat{x})≥J_{c}, then this is based on the minimization of J(x). The state x 42 is ascertained by the minimization. This is in particular done by means of Newton's method. If J(x)=[z−h(x)]^{T}R[z−h(x)], where R is the covariance matrix of the measurement values, then the state x 42, which minimizes J(x), can be ascertained by g(x)=∇ₓJ(x)=0. The zero point of g(x), which corresponds to the state x 42 to be ascertained, can be determined iteratively, and thus approximately, by x^{k=1}=x^{k}−λ[G(x^{k})]⁻¹ g(x^{k}). Here, G is the Jacobi matrix of J, x^{k} is the solution in iteration step k and λ is an attenuation constant, e.g., λ=1.

The state x 42 is ascertained by the iteration. Here x^{k=0}=x₀=\hat{x}, which means that the state determined by the AI 2 is used as the initial value of the iteration. The iteration starts, accordingly, at the state \hat{x} ascertained by the AI 2, and ends at the state x 42 to be ascertained following a specified termination criterion, for example when J(x)<J_{c}. A termination criterion different from the condition 62 can also be provided. The state 42 is thus ascertained by the classic state estimation based on the initial value \hat{x}. The classic state estimation 4 proceeds significantly faster as a result of the provided initial value that is ascertained by the AI 2, so that the computing time can be reduced or the overall accuracy of the state estimation can be increased.

Although the teachings herein have been more closely illustrated and described in more detail through the exemplary embodiments, the scope of the disclosure is not restricted by the disclosed examples, or other variations can be derived from this by a person skilled in the art without departing from the scope.

1. A method for ascertaining a state of an electrical grid, wherein the state of the electrical grid is represented by ascertained voltages and ascertained phase angles at one or more grid nodes of the electrical grid, the method comprising:
calculating the state using a computing unit, wherein the computing unit employs an iterative, numerical method on the basis of a plurality of measured values associated with the electrical grid;
wherein the numeral method begins with an initial value;
wherein the initial value includes an initial state ascertained from the measured values by an artificial neural network.

2. The method as claimed in claim 1, wherein the numerical method includes Newton's method.

3. The method as claimed in claim 1, wherein the measured values include a measurement vector comprising voltages, currents, real powers, and/or reactive powers associated with and acquired by grid nodes and/or cables of the electrical grid.

4. The method as claimed in claim 1, wherein the state is formed by a state vector indicating the voltages and phase angles at respective grid nodes of the electrical grid.

5. The method as claimed in claim 1, wherein the measured values are provided by a control system of the electrical grid.

6. The method as claimed in claim 1, wherein the numerical method minimizes a target function including a weighted, quadratic deviation between the measured values and a measurement model function depending on the state to be ascertained.

7. The method as claimed in claim 6, wherein the initial state is used as the initial value if the target function value is greater than or equal to a threshold value.

8. The method as claimed in claim 1, wherein the state ascertained by the artificial neural network is not used as the initial value if the state fails a chi-squared test with a specified probability threshold.

9. The method as claimed in claim 8, wherein the probability threshold is a value between 95 percent and 100 percent.

10. The method as claimed in claim 1, wherein the artificial neural network is trained and designed to ascertain states of the electrical grid from measured values associated with the electrical grid.

11. The method as claimed in claim 1, wherein the artificial neural network was trained using a training data set of measured values associated with the electrical grid and states of the electrical grid belonging to the measured values.

12. The method as claimed in claim 11, wherein the training data set was formed by one or a plurality of simulations and/or historic measured values and associated historic states of the electrical grid.

13. The method as claimed in claim 1, carried out repeatedly in accordance with specified time intervals.

14. An apparatus for ascertaining a state of an electrical grid, the apparatus comprising:
a computing unit with a memory and a processor;
wherein the state of the electrical grid is defined by voltages and phase angles at one or a plurality of grid nodes of the electrical grid; and
the memory stores a set of instructions and, when the processor accesses and executes the set of instructions, the processor causes the computing unit to calculate the state of the electrical grid on the basis of a plurality of measured values associated with the electrical grid by an iterative numerical method starting from an initial value;
wherein the computing unit uses an initial state ascertained by means of an artificial neural network from the measured values as the initial value.
